(19) United States
(12) Patent Application Publication
(10) Pub. No.: US 2020/0364807 A1
(43) Pub. Date: Nov. 19, 2020

(54) METHOD FOR SERVICING AND/OR REPAIR OF AN AGRICULTURAL WORK MACHINE

(71) Applicant: CLAAS Selbstfahrende Erntemaschinen GmbH, Harsewinkel (DE)

(72) Inventors: Christoph THOELE, Holdorf (DE); Patrick VENHERM, Sassenberg (DE); Thilo DASENBROCK, Vechta (DE)

(73) Assignee: CLAAS Selbstfahrende Erntemaschinen GmbH, Harsewinkel (DE)

(21) Appl. No.: 16/823,435

(22) Filed: Mar. 19, 2020

(30) Foreign Application Priority Data
May 14, 2019 (DE) 102019112558.8

(51) Int. Cl. G06Q 50/02; A01D 41/127; G06Q 10/06; G06Q 50/28; G06Q 10/00

(52) U.S. Cl. CPC G06Q 50/02; A01D 41/127; G06Q 10/20; G06Q 50/28; G06Q 10/06315

(57) ABSTRACT

A method for servicing or repair of an agricultural work machine, wherein an outage duration probability and/or a damage probability of the agricultural work machine and/or of a component part of the agricultural work machine is determined in an analysis routine based on operating data of the agricultural work machine, and wherein a delivery routine comprising a delivery of a replacement part corresponding to a component part of the agricultural work machine to a service point associated with the agricultural work machine is initiated based on the analysis routine for reducing the outage duration probability and/or the damage probability.

### CROSS-REFERENCE TO RELATED APPLICATIONS

This application claims priority under 35 USC 119 of German Application No. DE 10 2019 112 558.8, filed on May 14, 2019, the disclosure of which is herein incorporated by reference.

### BACKGROUND OF THE INVENTION

The invention is directed to a method for servicing and/or repair of an agricultural work machine and to a computer system for executing an analysis routine of the proposed method.

It is very important that agricultural work machines be operational, above all, during the harvest period. However, since delivery times for replacement parts of agricultural work machines are not short, the agricultural work machine may sit idle for a long period of time in the event of failure of a component part before the replacement part is delivered. At the same time, for reasons of economy, it is not possible to keep all necessary replacement parts continuously in stock worldwide. While it would be desirable for replacement parts to be delivered to a service point in the vicinity of the agricultural work machine basically on demand at the precise time that a component part fails, this is not easily possible because neither the moment when the component part fails nor the delivery time for the replacement part can be exactly determined. While the delivery time for the replacement part can usually at least be estimated reliably, failure of the component part can only be predicted very roughly based on experience.

Component parts such as a threshing drum, for example, are sometimes exchanged proactively before the start of the harvest period even though they could possibly have been used for several more years. At the same time, it may also happen that component parts fail sooner than expected and the agricultural work machine is therefore not ready for operation during the harvest period or remains in operation with defective component parts so that other components may also be damaged. In addition, some component parts may possibly not be fully serviceable for a period of time prior to failing and can therefore damage other component parts.

Heretofore, it has been attempted to mitigate these problems through regular maintenance and proactive replacement of parts that are still functional. This is not optimal either in technical or economical respects.

### SUMMARY OF THE INVENTION

The invention is based on the problem of refining and further developing the known methods for servicing and/or repairing an agricultural work machine such that damage to and/or outage of the agricultural work machine is reduced.

A key basic consideration is that the increasingly large amounts of data which can be collected during the operation of an agricultural work machine may be combined with increasingly precise logistical data in order first to determine an outage duration probability and/or a damage probability of the agricultural work machine and/or of a component part of the agricultural work machine and then to reduce this by selective initiation of delivery routines comprising a delivery of a replacement part corresponding to a component part of the agricultural work machine to a service point associated with the agricultural work machine.

In particular, a method is now proposed for the servicing and/or repair of an agricultural work machine. It is proposed that an outage duration probability and/or a damage probability of the agricultural work machine and/or of a component part of the agricultural work machine is determined in an analysis routine based on operating data of the agricultural work machine. It is further proposed that a delivery routine comprising a delivery of a replacement part corresponding to a component part of the agricultural work machine to a service point associated with the agricultural work machine is initiated based on the analysis routine for reducing the outage duration probability and/or the damage probability.

The proposed method accordingly makes it possible to eliminate or prevent the most likely failures of the agricultural work machine with high probability in a prompt manner or already in advance without the need to stock large quantities of replacement parts in the service points.

The initiation of the delivery routine comprises ordering the replacement part for delivery to the service point, and the delivery routine is executed. Preferably, the service point is located in spatial proximity to the agricultural work machine. At least within the framework of the initiation of the delivery routine, the point is not even that delivery of the replacement part be completed, because the probability of a long-lasting outage can already be appreciably reduced by ordering a replacement part.

The damage probability is a probability distribution for possible damage to the agricultural work machine and/or to a component part of the agricultural work machine due to a malfunction and/or reduced function of the component part of the agricultural work machine corresponding to the replacement part. This has to do with the probability that the agricultural work machine and/or a component part of the agricultural work machine is damaged and that this damage is the result of a malfunction or an impaired function of the component part corresponding to the replacement part. The damage probability preferably does not relate to the component part corresponding to the replacement part but rather to a different component part that may be damaged, possibly without being noticed, as a result of the malfunction and/or impaired function. In particular, this damage probability can be further reduced by installing the replacement part in the agricultural work machine.

The outage duration probability is a probability distribution for the duration of a possible outage of the agricultural work machine and/or of a component part of the agricultural work machine. This outage is a result of a failure of the component part corresponding to the replacement part. In this case, the outage duration probability can be reduced in a particularly efficient manner by initiating the delivery routine.

In the preferred embodiment, aggregate operating data of a plurality of other agricultural work machines and/or logistical data of the component part of the agricultural work machine corresponding to the replacement part are further taken into account in the analysis routine. This has the advantage that random effects can more easily be distinguished from systematic effects in case of larger amounts of data and that disguised interdependencies can more easily be identified. This makes it possible to determine the outage duration probability and damage probability more precisely. The latter can be selectively reduced by incorporating logistical data.

The operating data and/or the aggregate operating data can comprise utilization data, particularly a quantity of operating hours and/or engine load data and/or configuration setting data and parameter setting data and/or configuration setting modification data and parameter setting modification data and/or calibration data and/or error data, particularly an error type and/or an error frequency, of the agricultural work machine and/or of a component part of the agricultural work machine.

The aggregate operating data can include error propagation data and/or interdependence data about the component part corresponding to the replacement part and at least one further component part of the agricultural work machine, and the outage duration probability and/or the damage probability are preferably at least also associated with the further component part.

The logistical data comprise an expected delivery period of the replacement part, particularly a probability distribution of an expected delivery period time span, and/or an availability of the replacement part and/or an expected consumption of the replacement part by other agricultural work machines.

In a preferred configuration, the operating data are collected by means of sensors during an operation of the agricultural work machine. On the whole, precisely these data are particularly suited to map different influences on the operational readiness of the agricultural work machine so that it may be improved in a precise and efficient manner with the proposed method.

In yet another preferred embodiment form, environment data are further taken into account in the analysis routine. Since agricultural work machines are in direct contact with the weather and soil of the respective locality, operation of the agricultural work machines is heavily influenced by their environment. For example, a cutter unit will wear appreciably faster in rocky soil than in loamy soil. By taking these effects into account, it is possible to determine the outage duration probability and the damage probability for the respective agricultural work machine or one of its component parts with appreciably greater precision.

When construction data are further taken into account in the analysis routine, the complex system “agricultural work machine” can be mapped better so that mutual influences can be taken into account. This also leads to an improved determination of the outage duration probability and damage probability.

A diagnostic device can be used to collect the operating data. Insofar as the diagnostic device collects heterogeneous operating data, particularly operating data of different parts manufacturers and/or different part series, a good database can be built in a simple manner.

According to a further teaching, a computer system is claimed which is at least configured to execute the analysis routine of the proposed method. It is usually the case that a computer system of this kind is required because the volume of data can no longer be analyzed manually. All of the preceding remarks relating to the proposed method may be referred to.

### BRIEF DESCRIPTION OF THE DRAWINGS

The invention will be described more fully in the following referring to a drawing depicting a merely exemplary embodiment. In the drawing:

FIG. 1 shows the collecting of the database of the proposed method, including the proposed computer system.

### DETAILED DESCRIPTION OF THE EMBODIMENTS

The proposed method is used in the servicing and/or repair of an agricultural work machine 1. The agricultural work machine 1 may be a harvesting machine such as a combine harvester or the like. The proposed method comprises an analysis routine which is preferably executed by a computer system 2. The computer system 2 preferably comprises one or more servers 3.

The term “servicing” refers generally to obtaining the operational readiness of the agricultural work machine 1, while the term “repair” refers to the elimination of an imminent or existing failure of the agricultural work machine 1 or of a component part 4 of the agricultural work machine 1.

In the analysis routine, an outage duration probability and/or a damage probability of the agricultural work machine 1 and/or of a component part 4 of the agricultural work machine 1 is determined on the basis of operating data of the agricultural work machine 1.

The component part 4 of the agricultural work machine 1 may be, for example, a propulsion engine 5, a component part 4 of the propulsion engine 5 and/or a harvesting tool, particularly a cutting tool 6, of the agricultural work machine 1.

It is proposed that a delivery routine comprising a delivery of a replacement part 7 corresponding to a component part 4 of the agricultural work machine 1 to a service point 8 associated with the agricultural work machine 1 is initiated based on the analysis routine for reducing the outage duration probability and/or the damage probability. It should be noted at this point that an agricultural work machine 1 can be associated with a plurality of service points 8, that a plurality of agricultural work machines 1 can be associated with one service point 8, and that these associations may change over time. The service point 8 can be a workshop, a subsidiary of a manufacturer, or the like.

Very broadly, the proposed method is directed to enhancing the operational readiness of an agricultural work machine 1 through the initiation of the delivery routine. Before discussing the database, it should first be explained how these simple means can be used to lower the outage duration probability and/or the damage probability.

The initiation of the delivery routine preferably comprises ordering the replacement part 7 for delivery to the service point 8. This in itself reduces the outage duration probability and/or the damage probability because the required replacement part 7 is already in transit to the service point 8 or has arrived at the service point 8 by the time it is required. It should be noted at this point that the proposed method is, of course, carried out before the outage and/or damage occurs because the outage duration probability and the damage probability can no longer be influenced subsequently.

In a preferred further development of the proposed method, this method also comprises the delivery routine being executed. This provides the precondition for the actual installation of the replacement part 7 in the agricultural work machine 1. It is particularly preferable that the service point 8 is located in spatial proximity to the agricultural work machine 1. However, it is also conceivable that the service point 8 is located in spatial proximity to a future position of the agricultural work machine 1.

The usual operating cycle of an agricultural work machine 1 starts with the purchase of the agricultural work machine 1. It is operated subsequently, while the operating data accrue, and is serviced according to schedule. At any moment in this cycle, a failure of or damage to the agricultural work machine 1 and/or a component part 4 of the agricultural work machine 1 can occur. The proposed method serves at this point to reduce the outage duration probability and/or the damage probability by selective intervention. In concrete terms, this means that longer outages, particularly during the harvest period, are to be prevented or shortened and that damage is to be prevented as far as possible while taking into account the respective occurrence probabilities of possible outages and/or damage.

In the present instance and preferably, the damage probability is a probability distribution for possible damage to the agricultural work machine 1 and/or to a component part 4 of the agricultural work machine 1 due to a malfunction and/or reduced function of the component part 4 of the agricultural work machine 1 corresponding to the replacement part 7. This is preferably possible damage to a component part 4 of the agricultural work machine 1 that does not correspond to the replacement part 7. For example, a malfunction of a diesel feed of the agricultural work machine 1 could cause damage to the propulsion engine 5. While the diesel feed in this example would be quickly repaired if the correct replacement part 7 were available, the engine could be damaged by the end of the harvest period if the replacement part 7 had a long delivery time and the operator of the agricultural work machine 1 continued to operate the agricultural work machine 1 due to the necessity of bringing in the harvest.

Through timely initiation of the delivery routine for the replacement part 7, in this example, the diesel feed, engine damage can be prevented in a very simple manner. Correspondingly, the replacement part 7 for servicing the agricultural work machine 1 is preferably installed in order to reduce the damage probability. Accordingly, in this example, the delivery routine for the diesel feed is carried out and the diesel feed is exchanged in a timely manner so that there is no potential engine damage by the end of the harvest period.

It should be noted at this point that the term “probability distribution” refers to the distribution of probability over time and accordingly indicates the probability of the occurrence of the respective event at a certain point in time. For the proposed method, it is not necessary that this probability distribution can be calculated unambiguously or completely; it may already be sufficient to determine estimated values at some defined points in time.

In the present instance and preferably, the outage duration probability is also a probability distribution, but for the duration of a possible outage of the agricultural work machine 1 and/or of a component part 4 of the agricultural work machine 1 due to a failure of the component part 4 corresponding to the replacement part 7. The outage duration probability indicates at least the probability of an outage of a certain duration at at least one point in time. This component part 4 could be the cutting tool 6, for example, without which further operation of the agricultural work machine 1 would no longer be possible in a meaningful manner. Correspondingly, the agricultural work machine 1, as such, would be out of operation.

In the present instance and preferably, the replacement part 7 for repairing the agricultural work machine 1 is installed in the latter in order to remedy an outage of the agricultural work machine 1 and/or of the component part 4 of the agricultural work machine 1 and/or to shorten the duration of the outage and/or to prevent the outage. Accordingly, at the conclusion of the delivery routine the above-mentioned cutting tool 6 could be installed in the agricultural work machine 1 before an outage actually occurs, or it could at least be ordered before the outage and therefore installed in the agricultural work machine 1 sooner than if it were not ordered until the outage occurred.

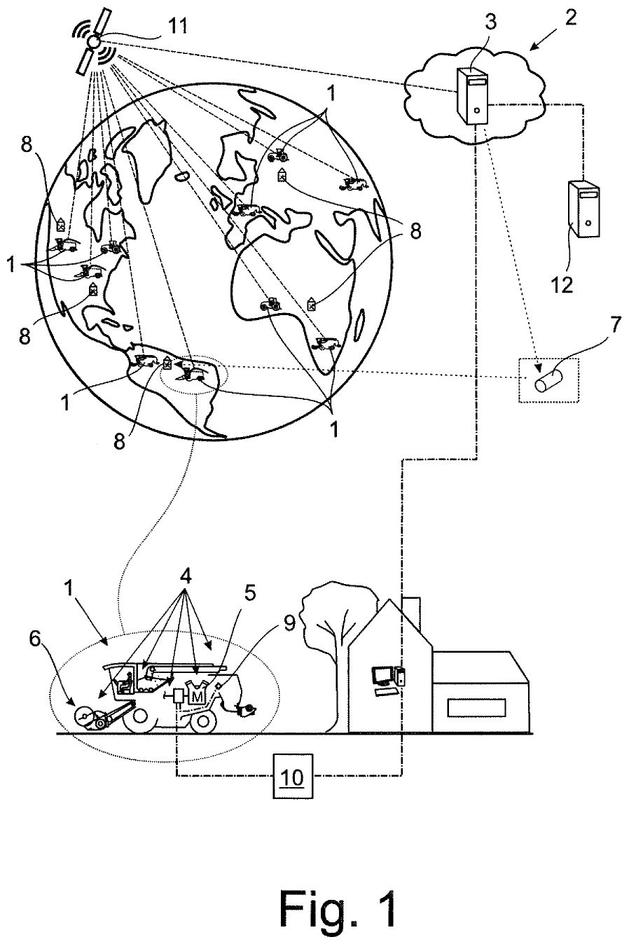

The data which can preferably be taken into account in the analysis routine and the provenance of these data will be described more fully in the following referring to the embodiment example in FIG. 1. In the present instance and preferably, the outage duration probability and/or the damage probability of the agricultural work machine 1 and/or of the component part 4 of the agricultural work machine 1 are further determined in the analysis routine based on aggregate operating data of a plurality of other agricultural work machines 1.

The term “plurality” is understood to mean that while this may also be only more than one other agricultural work machine 1, the plurality of agricultural work machines 1 preferably comprises at least 100 other agricultural work machines 1, more preferably at least 500 other agricultural work machines 1 and still more preferably at least 1000 other agricultural work machines 1. In particular, the plurality of agricultural work machines 1 can be distributed globally. This means that the plurality of agricultural work machines 1 preferably comprises at least agricultural work machines 1 from two countries, more preferably from at least five countries and still more preferably from at least two continents.

As is shown in FIG. 1, there are preferably a plurality of agricultural work machines 1 which are distributed globally. As will be explained later, the operating data of this plurality of agricultural work machines 1 are preferably transmitted to the server 3. The data of the plurality of agricultural work machines 1 can then be processed to form aggregate operating data by methods of data processing, particularly big data analysis. Statistical methods and/or pattern recognition methods may be used for this purpose, for example. Inferences about processes during the operation of the agricultural work machine 1 can then be drawn from these aggregate operating data preferably by means of the computer system 2, particularly in an automated manner. To this end, the operating data of the agricultural work machine 1 can flow into the process of pooling the operating data of the plurality of agricultural work machines 1 or can be compared subsequently. The kind of data pooling described here can also be applied in an equivalent manner to the further types of data which are yet to be described or those which have already been described.

In addition to the operating data and possibly the aggregate operating data, the outage duration probability and/or the damage probability of the agricultural work machine 1 and/or of the component part 4 of the agricultural work machine 1 are preferably further determined in the analysis routine based on logistical data of the component part 4 of the agricultural work machine 1 corresponding to the replacement part 7. Specifically, the logistical data can be utilized in particular to predict the possible duration of a possible outage or to determine the likelihood of damage due to the lack of opportunities for exchanging the corresponding component part 4.

The outage duration probability and/or the damage probability are preferably determined for more than one component part 4 of the agricultural work machine 1. The delivery routine is further preferably initiated when an outage duration probability and/or a damage probability of at least one component part 4 or of the agricultural work machine 1, as such, exceeds a threshold value or when a value derived therefrom, for example, a cost value, exceeds a threshold value.

In the present instance and preferably, the operating data and/or the aggregate operating data comprise utilization data, in particular a quantity of operating hours and/or engine load data, particularly of the propulsion engine 5. The utilization data may further comprise a rotational speed at certain times, a maximum rotational speed, a number of operating hours, a maximum use load being exceeded, and the like.

Additionally or alternatively, the operating data and/or the aggregate operating data can comprise configuration setting data and parameter setting data and/or configuration setting modification data and parameter setting modification data and/or calibration data. In a particularly preferred manner, the operating data comprise at least error data, particularly an error type and/or an error frequency. Very broadly, the operating data and/or the aggregate operating data can refer in each instance to the corresponding agricultural work machine 1 and/or at least one component part 4 of the agricultural work machine 1.

In the present instance and preferably, the operating data are collected during an operation of the agricultural work machine 1 by means of at least one sensor 9 of the agricultural work machine 1. This preferably also applies to the plurality of agricultural work machines 1.

Because agricultural work machines 1 are complex systems, it may happen that defects in a component part 4 impact other component parts 4. Such dependencies may be apparent, but often are not. It is only through the evaluation of the operating data of the plurality of agricultural work machines 1 that such cumulatively occurring defect chains can be made apparent. In the present instance and preferably, the aggregate operating data correspondingly include error propagation data and/or interdependence data about the component part 4 corresponding to the replacement part 7 and at least one further component part of the agricultural work machine 1, and the outage duration probability and/or the damage probability is preferably at least also associated with the further component part 4. Accordingly, the aggregate operating data make it possible to intervene in the operating flows of the agricultural work machine 1 even more precisely for servicing and/or repair thereof.

In the present case and preferably, the above-mentioned logistical data comprise an expected delivery period of the replacement part 7, particularly a probability distribution of an expected delivery period time span, and/or an availability of the replacement part 7 and/or an expected consumption of the replacement part 7 by other agricultural work machines 1. For example, it can happen that a replacement part 7 is in stock, but other agricultural work machines 1 will also need this replacement part 7 at some future time. Since the delivery period of a replacement part 7 depends on many factors, particularly also on transportation costs which vary appreciably when transported in a ship container compared to airfreight, for example, the logistical data preferably comprise cost data in addition or alternatively.

The operation of an agricultural work machine 1 can unfold very disparately depending on the environment. The atmospheric pressure at sea level can influence the functioning of the propulsion engine 5 differently than the atmospheric pressure at an altitude of 3000 meters. On a sunny day, an agricultural work machine 1 in a field to be cultivated may be exposed to high temperatures. Owing to the necessity of bringing in the harvest, the agricultural work machine 1 may also be used under very adverse weather conditions. In addition, use in a field on a hillside requires distinctly different characteristics than use in a field on a floodplain. Accordingly, the outage duration probability and/or the damage probability of the agricultural work machine 1 and/or of the component part 4 of the agricultural work machine 1 is preferably further determined in the analysis routine based on environment data associated with the agricultural work machine 1 and/or aggregate environment data associated with the plurality of agricultural work machines 1.

The environment data and/or the aggregate environment data can comprise weather data and/or geodata and/or climatic data and/or harvesting data, particularly harvest period data. Alternatively or additionally, the environment data can comprise micro-data and/or macro-data. The micro-data concern the immediate environment of the agricultural work machine 1, in particular a field to be cultivated, and the macro-data concern, at least potentially, a plurality of agricultural work machines 1. For example, the micro-data could comprise information that a field to be cultivated at a certain time was very rocky, while the macro-data could comprise information that agricultural work machines 1 located in the vicinity of the equator are exposed to high temperatures more frequently. It is not absolutely necessary for this that a plurality of agricultural work machines 1 are actually located in the vicinity of the equator; however, at least potentially, appreciably more agricultural work machines 1 can be located in the vicinity of the equator than would be expected on one individual field.

The environment data preferably comprises at least one dataset that is not collected by an agricultural work machine 1. Further, it is preferable that at least the macro-data, preferably all of the environment data, originate from data sources outside of the agricultural work machine 1. It is further preferable that the external data sources are also not directly associated with the agricultural work machines 1. This is the case, for example, with weather data of a weather service.

In the present instance and preferably, the outage duration probability and/or the damage probability of the agricultural work machine 1 and/or of the component part 4 of the agricultural work machine 1 are further determined in the analysis routine based on the construction data associated with the agricultural work machine 1. The construction data preferably comprise identification data, particularly production series data and/or manufacturer data, and/or technical characteristics of the agricultural work machine 1 and/or of a component part 4 of the agricultural work machine 1, particularly of the component part 4 corresponding to the replacement part 7.

As is shown in FIG. 1, the above-mentioned data can originate from very different sources. In the present instance and preferably, the operating data and/or the aggregate operating data originate from a diagnostic device 10 which will be described in the following, while the environment data preferably originate from another data source, in this case, the satellite 11. In the present instance and preferably, the construction data and logistical data originate again from another source, in this case, from a further server 12.

As has already been mentioned, the operating data of the agricultural work machine 1 and/or of the plurality of agricultural work machines 1 are preferably collected by a diagnostic device 10. This diagnostic device 10 is preferably connected to an agricultural work machine 1 in the course of servicing, for example, in the course of annual maintenance. The diagnostic device 10 is preferably not associated with any specific agricultural work machine 1 but rather can be connected to at least more than one agricultural work machine 1. Correspondingly, the diagnostic device 10 further preferably collects heterogeneous operating data, particularly of different parts manufacturers and/or different parts series.

In the present instance and preferably, the diagnostic device 10 is connectable to the agricultural work machine 1 in order to make a diagnosis of the agricultural work machine 1. The operating data can be collected while the diagnostic device 10 is connected to the agricultural work machine 1. Equally advantageously, however, it can be provided that the operating data are received by the diagnostic device 10 from the agricultural work machine 1 when the diagnostic device 10 is connected to the agricultural work machine 1. It can also be provided that the diagnostic device 10 collects test data while it is connected to the agricultural work machine 1. For this purpose, the diagnostic device 10 can further preferably actuate the agricultural work machine 1 to execute test routines.

In the depicted and, to this extent, preferred embodiment form, the operating data collected from the agricultural work machine 1 are transmitted to the diagnostic device 10 which is preferably subsequently connected to a computer 13 which then transmits the operating data to the server 3.

To protect against unauthorized adjustments, it can be provided that the operating data are protected by means of blockchain technology. For this purpose, the agricultural work machine 1 can store data as a blockchain, the diagnostic device 10 can in turn expand these data with its own data, and the server 3 can then check whether or not the data are coherent.

As has already been stated, the method can be partially or completely implemented by the computer system 2 depending on configuration. The computer system 2 which is the subject matter of an independent teaching is preferably adapted at least to execute the proposed analysis routine. In addition, the computer system 2 can be adapted to initiate the delivery routine. It can also be provided both with respect to the proposed method and with respect to the proposed computer system 2 that the computer system 2 automatically executes the analysis routine and subsequently initiates the delivery routine in an automated manner, particularly without intermediary intervention by the user. Equally advantageously, it can be provided that the computer system 2 automatically suggests an initiation of the delivery routine and this can be approved by the user.

In the present instance and preferably, the same computer system 2 determines the aggregate operating data from the operating data of the plurality of agricultural work machines 1. The computer system 2 can have a web application by means of which a user can initiate the delivery routine as explained above. All of the remarks pertaining to the proposed method may be referred to as regards the computer system 2. Owing to the complexity of the data volume, the computer system 2 is also preferably obligatory in the proposed method; that is, at least the analysis routine and/or the pooling of operating data of the proposed method are preferably not possible manually.

The computer system 2 is preferably not associated with an agricultural work machine 1 and, in particular, is cloud-based.

### REFERENCE NUMERALS

1 agricultural work machine

2 computer system

3 server

4 component part

5 propulsion engine

6 cutting tool

7 replacement part

8 service point

9 sensor

10 diagnostic device

12 further server

13 computer

What is claimed is:

1. A method for servicing and/or repair of an agricultural work machine, comprising:
determining an outage duration probability or a damage probability of the agricultural work machine and/or of a component part of the agricultural work machine in an analysis routine based on operating data of the agricultural work machine, and
initiating a delivery routine comprising a delivery of a replacement part corresponding to a component part of the agricultural work machine to a service point associated with the agricultural work machine, based on the analysis routine, for reducing the outage duration probability and/or the damage probability.

2. The method according to claim 1, wherein the step of initiating the delivery routine comprises ordering the replacement part for delivery to the service point and executing the delivery routine.

3. The method according to claim 1, wherein the damage probability is a probability distribution for possible damage to the agricultural work machine and/or to a component part of the agricultural work machine due to a malfunction or reduced function of the component part of the agricultural work machine corresponding to the replacement part.

4. The method according to claim 1, wherein the replacement part for servicing the agricultural work machine is installed in the agricultural work machine in order to reduce the damage probability.

5. The method according to claim 1, wherein the outage duration probability is a probability distribution for the duration of a possible outage of the agricultural work machine and/or of a component part of the agricultural work machine due to a failure of the component part corresponding to the replacement part.

6. The method according to claim 1, further comprising the step of installing the replacement part in the agricultural work machine for repairing the agricultural work machine in order to remedy an outage of the agricultural work machine or of the component part of the agricultural work machine or to shorten the duration of the outage and/or to prevent the outage.

7. The method according to claim 1, wherein the outage duration probability or the damage probability of the agricultural work machine or of the component part of the agricultural work machine is further determined in the analysis routine based on aggregated operating data of a plurality of other agricultural work machines or logistical data of the component part of the agricultural work machine corresponding to the replacement part.

8. The method according to claim 7, wherein the operating data or the aggregate operating data comprises at least one of utilization data, particularly a quantity of operating hours and/or engine load data, configuration setting data, parameter setting data, configuration setting modification data, parameter setting modification data, calibration data or error data, particularly an error type or an error frequency, of the agricultural work machine and/or of a component part of the agricultural work machine.

9. The method according to claim 7, wherein the agricultural work machine has at least one sensor, and wherein the operating data are collected during an operation of the agricultural work machine by means of the at least one sensor.

10. The method according to claim 7, wherein the aggregate operating data include error propagation data or interdependence data about the component part corresponding to the replacement part and at least one further component part of the agricultural work machine, and wherein the outage duration probability and/or the damage probability are associated with the further component part.

11. The method according to claim 7, wherein the logistical data comprise at least one of an expected delivery period of the replacement part, a probability distribution of an expected delivery period time span, an availability of the replacement part or an expected consumption of the replacement part by other agricultural work machines.

12. The method according to claim 1, wherein the outage duration probability and/or the damage probability of the agricultural work machine or of the component part of the agricultural work machine is further determined in the analysis routine based on environment data associated with the agricultural work machine and/or aggregate environment data associated with the plurality of agricultural work machines, wherein the environment data and/or the aggregate environment data comprise weather data, geodata, climatic data or harvesting data, wherein the environment data further comprise micro-data or macro-data, wherein the micro-data concern an immediate environment of the agricultural work machine, in particular a field to be cultivated, and wherein the macro-data concern a plurality of agricultural work machines.

13. The method according to claim 1, wherein the outage duration probability or the damage probability of the agricultural work machine or of the component part of the agricultural work machine are further determined in the analysis routine based on construction data associated with the agricultural work machine, wherein the construction data comprise identification data, production series data, manufacturer data, technical characteristics of the agricultural work machine or of a component part of the agricultural work machine.

14. The method according to claim 1, further comprising the step of collecting the operating data of the agricultural work machine and/or of the plurality of agricultural work machines by a diagnostic device.

15. The method according to claim 14, wherein the diagnostic device is configured to be connected to the agricultural work machine in order to make a diagnosis of the agricultural work machine, and wherein the operating data are collected while the diagnostic device is connected to the agricultural work machine, or the operating data are received by the diagnostic device from the agricultural work machine when the diagnostic device is connected to the agricultural work machine.

16. A computer system adapted to execute the analysis routine according to claim 1, wherein the computer system is adapted to initiate the delivery routine and determine the aggregate operating data from operating data of a plurality of the agricultural work machines, wherein the computer system has a web application by means of which a user can initiate the delivery routine, of the computer system is adapted to automatically initiate the delivery routine.
